(19) United States
(12) Patent Application Publication
(10) Pub. No.: US 2015/0341300 A1
(43) Pub. Date: Nov. 26, 2015

(54) METHOD AND SYSTEM FOR AUTOMATED EMAIL CATEGORIZATION AND END-USER PRESENTATION

(71) Applicant: SUBLIME-MAIL, INC., Palo Alto, CA (US)

(72) Inventors: James E. Swain, Menlo Park, CA (US); Rebecca D. Swain, Menlo Park, CA (US)

(21) Appl. No.: 14/716,776

(22) Filed: May 19, 2015

Related U.S. Application Data
(60) Provisional application No. 62/000,961, filed on May 20, 2014.

(51) Int. Cl. H04L 12/58; G06N 99/00; G06F 17/30

(52) U.S. Cl. CPC H04L 51/22; G06F 17/30601; G06N 99/005

(57) ABSTRACT

A system and method for presenting a summarized view of a plurality of emails are provided. The plurality of emails corresponding to a set of email inboxes are received at a server. A combination of static rules and machine-learned rules is applied to each of the plurality of emails to determine a set of characteristics of the email. Each of the plurality of emails is assigned to one of a plurality of classifications based on the determined set of characteristics of the email. Information is provided to a client computer to cause the client computer to generate a display of an overview of the plurality of classifications and emails that have been assigned to each of the plurality of classifications.

### CROSS-REFERENCE TO RELATED APPLICATIONS

The present application claims the benefit of U.S. Provisional Patent Application 62/000,961, entitled, “Method and System for Automated Email Categorization and End-User Presentation”, filed on May 20, 2014. The contents of U.S. Provisional Patent Application 62/000,961 are hereby incorporated by reference.

### BACKGROUND OF THE INVENTION

The present invention relates to a method and system for organizing emails. In particular, it presents a method and system for assigning classifications to emails and presenting an overview of the emails based on the assigned classifications.

### BRIEF SUMMARY OF THE INVENTION

The disclosed subject matter relates to a machine-implemented method for presenting a summarized view of a plurality of emails. The plurality of emails corresponding to a set of email inboxes are received at a server. A combination of static rules and machine-learned rules is applied to each of the plurality of emails to determine a set of characteristics of the email. Each of the plurality of emails is assigned to one of a plurality of classifications based on the determined set of characteristics of the email. Information is provided to a client computer to cause the client computer to generate a display of an overview of the plurality of classifications and emails that have been assigned to each of the plurality of classifications.

The disclosed subject matter also relates to a non-transitory computer-readable medium comprising instructions stored therein for presenting a summarized view of a plurality of emails. The instructions, when executed by a system, cause the system to receive the plurality of emails corresponding to a set of email inboxes. A combination of static rules and machine-learned rules is applied to each of the plurality of emails to determine a set of characteristics of the email. Each of the plurality of emails is assigned to one of a plurality of classifications based on the determined set of characteristics of the email. Information is provided to a client computer to cause the client computer to generate a display of an overview of the plurality of classifications and emails that have been assigned to each of the plurality of classifications.

According to various aspects of the subject technology, a system for presenting a summarized view of a plurality of emails is provided. The system includes one or more processors and a machine-readable medium including instructions stored therein. When the instructions are executed by the processors, the instructions cause the processors to receive the plurality of emails corresponding to a set of email inboxes. A combination of static rules and machine-learned rules is applied to each of the plurality of emails to determine a set of characteristics of the email. Each of the plurality of emails is assigned to one of a plurality of classifications based on the determined set of characteristics of the email. Information is provided to a client computer to cause the client computer to generate a display of an overview of the plurality of classifications and emails that have been assigned to each of the plurality of classifications.

Additional features and advantages of the subject technology are set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide further understanding of the subject technology and are incorporated in and constitute a part of this specification, illustrate aspects of the subject technology, and together with the description serve to explain the principles of the subject technology.

FIG. 1 illustrates an example of a system utilized to present a summarized view relating to a user's emails.

FIG. 2 provides an illustration of a decision process of a classifier of the system.

FIG. 3 depicts an example dashboard presented on a mobile communications device by the system.

FIG. 4 depicts an example dashboard presented on a tablet by the system.

FIG. 5 provides a representative thread view provided by the system.

FIG. 6 provides a representative view of an archived thread of the system.

FIG. 7 provides an example profile view of the user.

FIG. 8 provides a depiction of the Cloud Services architecture used by the system.

FIG. 9 illustrates an example method for presenting a summarized view relating to a user's emails.

FIG. 10 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Email has become a major source of stress in the modern workplace. Repeated surveys and studies have confirmed that email management has become a task that consumes a significant portion of an individual's time. Various strategies have been proposed by productivity gurus, life-hackers and technology startups, but in each case the focus has been on making incremental improvements to the current interface or on reducing the negative impact that managing email has on our productivity. The proposed solutions, however, fail to reduce the total time that users spend processing email.

Most users nowadays have multiple email accounts (e.g., personal email accounts with email providers, work email accounts, school/alumni email accounts, etc.). Cursory examination of a typical email account reveals that a handful of distinct use cases are mixed together into a single inbox, and must be curated manually. This mixing makes the development of tools to process the inbox problematic, as the email abstractions are too broad to be useful. And, while there are tools that attempt to solve a subset of the use cases, these tools do so without any consideration of the way that email is being currently used and thus fail to provide a satisfactory migration path away from email.

Certain mobile email clients may have the capacity to display emails from multiple accounts in a single view; however, this interleaving is performed on the client side. As such, this client side interleaving produces a presentation artifact that lacks any intelligent sorting beyond simple chronology. Some web clients, such as Gmail™, don't provide for unified displays of different accounts for a single user. Thus, each separate account requires an additional tab in the web browser to be displayed. Accordingly, when a user considers which email to review first, it is necessary for the user to select an account with which to start.

There are a number of different actions that a user can perform in an email client that are usually promptly reflected on the email server. The “Seen” flag is used to distinguish between emails that the user has already read and those that they have not been read. In many clients, unread or new emails are visually distinguishable from read or old emails through the use of colored fonts or boldfaced type. When the user reads a new email, the client sets the “Seen” flag on the server. Many clients are also configured to store emails that the user has started to compose but not yet sent as draft emails. Web clients such as Gmail™ may automatically save a copy of an email that is being drafted every minute. The web clients save these draft emails on the server where they are made visible to other clients. Similarly, most web clients store copies of sent emails on the web clients' servers. Gmail™, for example, collects messages sent and received about a specific subject into a single thread. When a user deletes an email the email is removed from the email provider's server (sometimes after a visit to a trash folder).

In one aspect of the subject technology, “Seen” flags can be tracked to determine if the user has recently read an email from any client. New draft emails, changes to existing draft emails, and sent emails may also be tracked. Every time an inbox agent of the system processes the user's inbox, the various server indicators may be checked. The number of messages that have had the “Seen” flag set or cleared is counted; the number of new drafts is counted and existing drafts are checked to see if they have been edited; and the number of new sent messages is counted and the number of messages that have been deleted is counted. The counters are then written into the system's database, along with a corresponding timestamp. If any of the counters are non-zero, then the user is determined to have been active in the period between that timestamp and the previous record for the same mailbox.

To estimate the amount of time required for a user to navigate through emails, let N be the total number of emails that a user needs to process, let I be the average time that a user spends choosing the next email to work on, and let P be the average time that a user spends on one email. Accordingly, the total time a user spends in their inbox, T, can be approximated as T˜N (I+P). Note that this is a proportionate relationship that simply reflects the fact that if any one of N, I or P is reduced, while the others remain fixed, then the total time T will also be reduced.

In order to reduce the total time spent working on email, a system for eliminating the email inbox and moving email back to a simple data transport mechanism is provided. By utilizing new tools and interfaces described herein, each of N, I and P may be reduced. In some embodiments, emails across several email accounts and threads are aggregated together into conversations, regardless of the account involved and uniform view of the combined accounts is provided. This cross-account threading allows for the treatment of conversations as a single entity for the purposes of archiving, deleting or any other manual or automated actions.

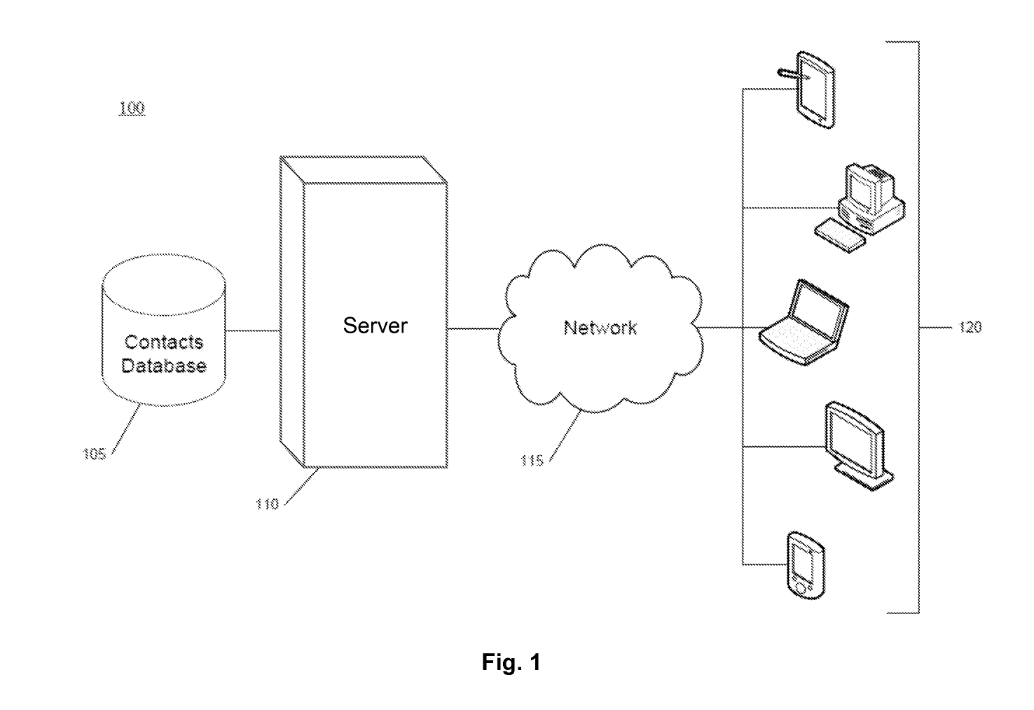

According to various aspects of the subject technology, a system for presenting an overview of the emails based on assigned classifications is provided. FIG. 1 illustrates an example of a system utilized to provide an organized list relating to a user's email, in accordance with various aspects of the subject technology. System 100 may comprise one or more servers 110 connected to one or more client devices 120 (e.g., desktop, mobile, or other computing devices) via a network 115 (e.g., the Internet, a wide area network, a local area network, etc.). The one or more servers 110 may also be connected to one or more databases 105 storing a plurality of user accounts and associated information such as user profiles and emails. Upon request from client device 120, the server 110 may retrieve the user profiles and emails from the database 105 and may send them to requesting client device 120. Client device 120 may utilize the user profile and email information to generate a graphical representation of one or more organized list to which the emails may belong.

The system may reorganize the user's email inbox into constituent parts by classifying each email as belonging to one of several use cases. By performing inbox reorganization to the constituent use cases, the system can provide value to the user. Rather than the user being presented with a disorganized mixture of invitations to accept, documents to review, and messages to respond to (all of which needs to be mentally reorganized), the user can begin by deciding which use case the user wishes to address. For example, a user might want to check if any new task requests have come in from a co-worker, but the user may not have time to review a large document. The user can thus ignore all the emails except ones that have been identified as being in a particular classification (e.g., “Task Requests”) and quickly view the list of requests.

The system may treat each email as a specific object and reorganize the emails into distinct use cases. That is, the system may classify the emails as Task Requests, Invitations or Documents. The reduction in abstractions also provides the opportunity to automate some of the handling of the emails. For some use cases the automated handling might be simply stripping out extraneous content. For example, the salutations and pleasantries at the beginning and end of a Task Request can be omitted from being displayed, thus leaving only the bare request. For other use cases the system may be able to extract information from the email and take action on the user's behalf.

In some embodiments, the system may reduce number of emails a user needs to personally handle in two ways. First, multiple emails in a thread can be rolled up into a single summary. In one example, “for your information” (FYI) threads of emails, which typically provide an incremental accumulation of information, may be summarized. A passive participant in a collaborative discussion may only be interested in the final conclusion of the discussion. Thus, rather than presenting a thread of multiple emails for the user to read through, the system may present a single, well-formatted summary to the user. Since the system has access to an entire conversation thread, de-duplication may be performed by searching each message in the thread for an exact match to sentences and paragraphs of messages that appear earlier in the thread, and removing the duplicates.

For example, some workflow processes generate multiple notification emails where the user may only be interested in the outcome or current state. By removing duplicate text blocks, the system may present to the user a more concise overview of the discussion. Thus, the user may able to quickly identify the outcome of the discussion. In contrast, some workflow processes generate fairly unique content for each phase of the workflow. However, there often is enough information to string the process emails together (e.g., a case number) in each email, even though the actual data about a particular state is generally not repeated in subsequent messages.

Second, the handling of emails may be entirely automated. By obtaining additional configuration information from the user, the system may completely eliminate user involvement in certain tasks such as scheduling. This may be accomplished by having the user establish acceptable meeting windows and/or provide project or meeting organizer prioritization information. With this information, workplace scheduling may be entirely delegated to the system.

### Email Classifications

In some aspects of the invention, the system may classify each email into one of five distinct classes based on two complementary ideas that define the classes: 1) emails should be assigned to classes based on what we can do with them; and 2) classes of emails should be distinguished by urgency and relevance.

Messages

Modern email has enabled a revolution in working practices by permitting millions of workers to operate remotely. One-on-one communication that used to be conducted in person or over the telephone has migrated over to email and instant messaging while collaborative discussions involving multiple parties also often take place over email. No matter what other purposes the inbox has been put to, some number of emails is always going to require a personal response from the user.

Some examples of emails that are to be classified as “Messages” include personal communications from family members and close friends, requests for information from a supervisor or colleague, updates to a discussion in which the user is actively participating, etc. Additionally, emails that cannot be classified into one of the other buckets may also be classified as “Messages.”

In some embodiments, a special class of one-on-one message may be identified as introductions. For example, an email including contact information for another user may be received. By analyzing the text of the email, the system may identify a name and some combination of an email address, mailing address, phone number or email address. These introduction type messages are generally short and simply provide the contact details of either the author or someone cc′d on the message. Thus, rather than appear as a simple message, these emails may be presented to the user as a new contact. The user may then be prompted to either add the contact to their address book or ignore the invitation.

FYIs

Other emails may be classified as “FYIs.” Email has become the de-facto mechanism for notifying users of everything from upcoming meetings to the current state of a recent Amazon order. In an enterprise environment, email may also be used to update employees about the progress of various workflows (e.g., performance reviews and budget approvals etc.). For any sequence of FYIs that contains more than a single message, a current state of the workflow is usually the most interesting to the user, although the ability to review the timeline of the workflow must always be preserved. Examples of emails that would be classified as FYI include notifications about paid time off (PTO) requests, online order status and shipping information, updates to a discussion that the users is passively participating in, etc.

By definition, FYIs do not require any user action, and thus no automation is required. A collection of FYIs, however, may be rolled up under a single workflow, and a meaningful statement about the current state of the workflow can be extracted from either the subject line or the body of the last email message to be presented to the user. For example, emails automatically generated by common processes (e.g., Amazon orders), are highly structured and consistent in both subject line and email body, thus making the emails very amenable to simple regular expression matching. These emails often contain a unique identifier, such as an order number, that can be used to associate emails connected with a single transaction. This provides an easy way to thread together emails from a single transaction. For each common process, the system may identify the different stages of the process and create regular expressions that will both identify the stage that each email corresponds to, and extract relevant data about that stage (such as the expected delivery date). Once all of the emails that are associated with a single transaction are identified, and all stages of the process are known, the system is able to suppress the raw emails associated with the workflow and simply present the current state along with any pertinent data. For example, “Your order has been shipped and will be delivered tomorrow.”

Documents

Another classification of emails is “Documents.” As offices have become more and more paperless, hard drives and document repositories have replaced binders and filing cabinets. Email has been adopted as a mechanism for both sharing documents (either as attachments or as blocks of text within the body of the email) and for receiving notifications from document repositories. As with FYIs, it is typically the latest version of any such document that is of interest. While there are a number of existing solutions that are useful for maintaining large documents in the inbox, many users are reluctant to use them because of poor user interface and/or integration with email. Thus, in some embodiments, the system provides an effective document repository with a robust version control that allows the user to jump to the latest version of a document or step back through the history of changes and accompanying comments.

In order to maintain version control, the system may measure similarities between documents and determine the likelihood that they are different versions of the same document. Whenever a document is found to be attached to a user's email (inbound or outbound), the document may be compared to other documents attached to the thread to which the email belongs. If the system determines that it is sufficiently likely to be a new version of the same document, then the differences between the two documents are computed and the new document is recorded as a new version of the old. Any unique text in the body of the email to which the document is attached may be extracted and recorded as a comment to the changes in the document.

When the user returns to view the email thread, the system may present a single document, rather than displaying all the attachments as individual documents. When the user selects the document for viewing or downloading, the default action may be for the system to provide the most recent version of the document. The user interface, however, allows the user to see all versions of the document, and also may provide for downloading or viewing an earlier version. The user may also view the comments associated with each version.

Task Requests

The email inbox has also become a disorganized to-do list to which anyone who knows a user's email address can add items by simply emailing the user. Since most clients organize the inbox in reverse chronological order with the most recent emails at the top, more recent additions to the list gradually push previously committed items out of view and essentially “out of mind.” Unless users are given control over the action items they accept, any productivity gains generated by a new solution may end up being wasted working on the wrong tasks.

While the action being requested of the user might be time consuming or non-urgent, accepting or rejecting the request is often time-sensitive, as the requestor may need to either modify his plans or find someone else to do the work if the request is rejected. In some embodiments, emails with these characteristics may be identified and classified as “Task Requests.” Examples of emails that would be classified as Task Requests include automatically generated password reset requests, specific instructions to perform work from a colleague, assignment of chores from a housemate, etc.

In some embodiments, the system will distill the action item out of the email to present the task requests in a standardized format, thereby allowing the user to rapidly accept or reject action item requests. Much like calendaring today, accepting an action item may automatically add an item to an external to-do list application, and rejecting an action item may send a canned response back to the requestor. Task requests may be an invitation to perform some action, similar to an invitation to attend a meeting. However, standard attachment formats (e.g., iCal) may be used to convey the details of a meeting invitation. A similar format can be utilized for task request. Whereas an iCal object contains information such as host, reason, place, start-time and end-time, a task request (e.g., an iTask) may be an object containing information such as requestor, task, effort-estimate and deadline.

In the absence of a standardized format like iTask, task requests that arrive via email do so in the body of an email. The actual task request is often sandwiched between a greeting at the beginning of the email and some pleasantries at the end. Natural Language Processing can be used to extract the sentence or two that has been identified as describing the task being requested, along with any deadline and effort estimate. Once extracted, this information may be recorded as a task request. When the user views the request, the user would see the task request in a standardized view, rather than the original text of the email.

Deeper analysis of action requests may also permit the system to set appropriate prioritization on the items added to the to-do list (based on requestor or project), and even estimate the amount of time required to perform the task and hence the likely delivery date. For example, the Chief Technology Officer of a startup may have many demands over a limited period of time. Those requests may come from any of a variety of collaborators working on different products across various projects within a product. The requests may include reviewing multiple versions of a script for a promotional video, reviewing multiple versions of a pitch presentation, making revisions to the company's website to ensure consistent branding with the company's social media presence, weighing in on a number of technical discussions concerning the future architecture of the software suites, and providing feedback to outside counsel regarding different issues.

In general, task requests from certain individuals (e.g., a superior, direct report) take priority over all other tasks. However, certain time sensitive events may elevate another task to a higher priority level. Thus, when the system provides task requests, the system can attempt to extract information about the project by looking for a reference to the specific project in either the subject line or body of the email. Having ascertained the project and requestor for a task, the system can check if the user (the Chief Technology Officer in this case) has marked either (or both) of the requestor or task as higher priority. The system may then flag them appropriately in the task request queue view.

Invitations

Email is also widely used nowadays for scheduling meetings, for which emails were not originally designed. This example of “feature creep” on email has led to the development of standardized data format that can be automatically passed to an external calendaring application. Even with the use of standardized data format, the user is still required to manually accept or reject each meeting request. Furthermore, meetings that involve many busy participants may require multiple iterations to find a suitable time slot, and often have a cascading impact on previously scheduled meetings. The challenge with handling the scheduling of such meetings is preserving the user's control over the projects they work on and the meetings they attend while relieving them of the burden of scheduling those meetings. These types of emails may be classified as invitations.

Consider a meeting involving multiple VPs of a corporation. The parties who need to attend may already have full schedules and the task of finding a mutually agreeable time to meet usually falls to a project manager working with a group of administrative assistants. Thus, the project manager simply serves as a communication channel between the administrative assistants. The assistants may have visibility into each of the VP's schedules, knowledge about when each VP is prepared to meet, and knowledge about the relative importance of this meeting compared to other meetings that have already been scheduled. This group may find the first mutually agreeable time, and may move less important meetings around to create the necessary opening. This process, however, may be fully automated by a system that is able to obtain information such as a user's calendar and a ranking of how important each meeting is to the user.

For example, when the user first configures his account on the system, the user will be invited to define meeting windows for both work and personal activities. These meeting windows may constrain when the system can schedule these types of conference items. The meeting windows are configurable through the user's profile and can be overridden for one-off events. The system will classify conference requests as personal or work, and then by project or host. When the first conference request for a new project or individual comes along the user will be asked to prioritize this project relative to the other projects that Sublime-Mail knows about. This prioritization will be used to resolve scheduling conflicts. Project prioritization may also be configurable through the user's profile and can be overridden for one-off events as well.

In some embodiments, the user may specify a how far into the future their schedule must be stable by providing a freeze period where meeting cannot be schedules (e.g., no earlier than 30 minutes from now). This allows the user to insert some predictability into the user's schedule by not opening up the entire calendar for meetings. The user may also configure how far into the future (e.g., no more than one month) conferences can be added to their calendar. A similar parameter will also be available to conference hosts for creating meetings.

Priority

Classification is a universal property of emails. The system asserts that there are a small number of classifications that can be applied to emails for all users. Once emails have been classified, it's possible to automate a number of operations to be performed on each class of email. Priority, on the other hand, is a highly personal concept. Priority is based on the sender and the content of an email, and dictates the order in which threads should be handled within a class. For example, the fact that a document was sent by an important person may not change the fact that the user can quickly view and acknowledge Task Requests between meetings, but must set aside some time to read and process the document sent by the person of importance.

### Threading

In some embodiments, the system assigns messages to threads based on the subject line and the participant list. The system removes any leading ‘re’ or ‘fwd’ that have been inserted by a mail client and creates a normalized subject line. Messages that have matching normalized subject lines are identified as candidates for threading. Messages that also have overlapping participant lists (excluding the user himself) are considered to be part of a single message thread. Each new message that is processed is checked against the existing set of threads. If the message does not match with any existing thread then a new thread is created. Some messages will meet the criteria to be members of more than one thread. This happens when two parallel conversations about the same subject start to involve an overlapping set of participants. The result is a new thread that is formed by merging the existing threads. In some embodiments, all the existing messages and the new message may be associated with the new merged thread.

### Classifying

The classifier uses a combination of static rules and machine learning to separate message threads into several classes. While the example used herein describes five classes, these classes are described for exemplary purposes, and thus should not be taken as limiting the scope of the subject technology.

Static rules are rules that remain the same over time (unless the change is implemented by an administrator or user). An example static rule may be that any message that has a calendar attachment is classified as an invitation. Static rules such as the one described are run before any others rules are applied.

Machine learned rules, on the other hand, utilize a variety of different automated classifiers as input to the classification. One classifier may consider the subject line of the email, one may consider the body of the email, and a third may process the metadata (to, from, attachments, etc.). The final decision of the machine learned rule is based on the majority view of the classifiers. When there is no majority, deference may be given to the metadata classifier, unless the body classifier determines that the verdict should be Task Request.

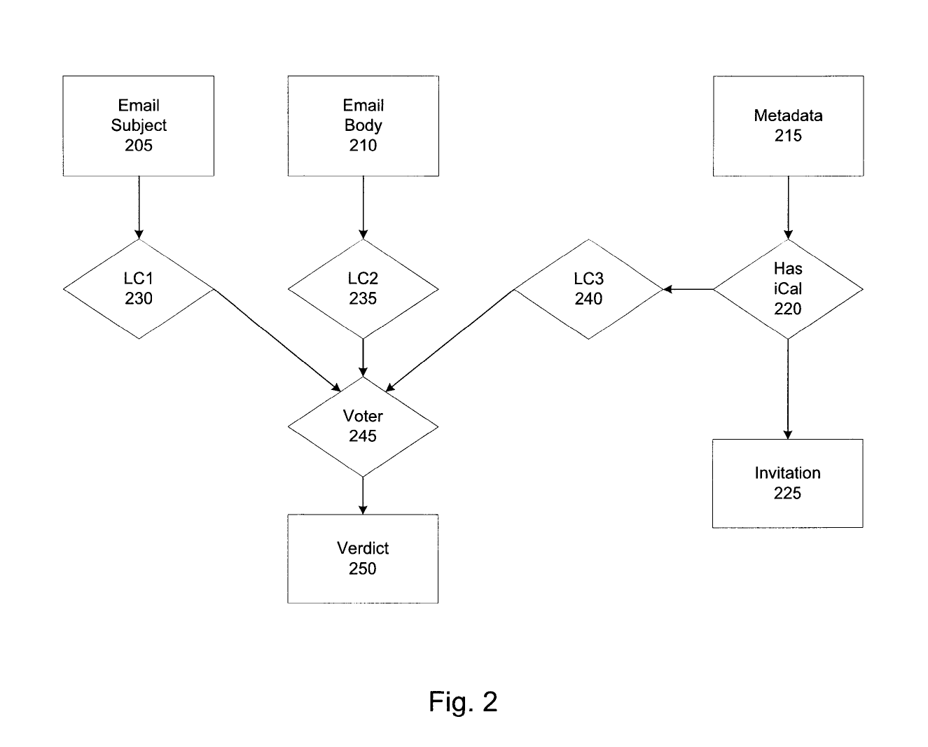

FIG. 2 provides an illustration of a decision process of a classifier of the system. The raw email is initially parsed to extract the subject line 205, the body 210 (plain text and/or html) and metadata 215 (such as number and type of attachments and the number and ID of all addresses) of the email. Before any heavy computation is performed, a simple static rule is applied at 220 to classify any email with an iCal attachment as an invitation 225. If no iCal attachment is present, then three independent linear classifiers 230, 235 and 240 operate on each of the three inputs to render three candidate verdicts. Those candidate verdicts are then passed to a voter 245 that renders the final verdict 250.

If two or more of the candidate verdicts are the same, then the voter 245 determines that verdict to be the final verdict 250. If all three verdicts are different, then the voter 245 defers to LC3 240, unless the LC2 235 verdict is a “Task Request,” in which case the verdict is Task Request.

Classification may be performed one single message at a time. For the non-conference message classes, this can result in a mismatch between the classification of the message and the classification of the thread it belongs to. The system, thus, may use a hierarchy in the order of task request, then document, then message, then FYI, to select the final classification of the thread. For example, if an email results in a mismatch between a document class and a task request class, the email will be classified as a task request, since task request sits higher on the hierarchy chain.

Other tasks that run on the mailbox agent may be triggered by user actions. For example, if the user reads an email or responds to a meeting invitation that is captured in the system database, a message is queued to the message broker that will instruct the mailbox agent to update the Seen flag on the IMAP server or send the response via the SMTP server. Every action that the user can perform is handled by a different mailbox agent task.

In addition, a trainer task may run on the system in some embodiments. The trainer task may use supervised machine learning to establish rules to maximize the separation between different classes for the three linear classifiers used by the system. The system may capture a subset of the email messages processed by the system into an email corpus. The correct classification of each email is established by direct and indirect feedback from the users. That is, the users can be explicitly asked to manually classify an email (direct) or the users can correct an incorrect classification (indirect). The resulting labeled corpus is used to train three independent linear classifiers that are used to classify each new email.

Linear classifiers treat objects as a point in n-dimensional space by converting the document into a vector with n components in a process called vectorization. The precise meaning of those components depends on the content type. When the input object is a block of text, such as the subject line or body to an email, then the vector may be a count of the number of occurrences of several hundred distinctive words. For metadata in an email, the vector may have components that indicate if the email had an attachment of a certain type, or if it was addressed to a specific individual.

After vectorization, the labeled corpus may be represented as four clusters of points in n-dimensional space with clear separation between the clusters. The training process adjusts the parameters of the linear classifier in order to define surfaces in the n-dimensional space that maximize the probability that emails within any given cluster will be on one side of the surface, with emails from any other cluster being on the other side of the surface.

The resulting rules are stored on a file system that may be accessible to both the inbox agent and the trainer, and may be subsequently used by the system for maximizing the separation between different classes for the three linear classifiers, as described above. The three classifiers may be independently trained on a single training set (comprising one half of the labeled corpus) and then independently evaluated against a single testing set (comprising the other half of the labeled corpus). By combining the results of the linear classifiers, the combined misclassification rate may be minimized.

While the system mostly uses classifiers to split up a customer's email into buckets, in some embodiments, the system may use language processing. For example, before being classified, an email may be analyzed to extract information like task request, invitations and process updates that are embedded in the text of the email. As with invitations, where an email will only be labeled as an invitation if an iCal attachment exists, an email may be labeled as a task request if such a request is extracted from the email. Similarly, an email may be labeled as a document if a document that can be handled by the version control system is found within the email.

Clustering classifiers will then only be needed to separate whatever remains into FYI or Message. While the other classes are more amenable to separation based on specific data extraction using natural language processing, the FYI and Message classes (as defined at the time of writing) are likely to need to be separated using a linear classifier (or an equivalent statistical technique).

### Dashboard

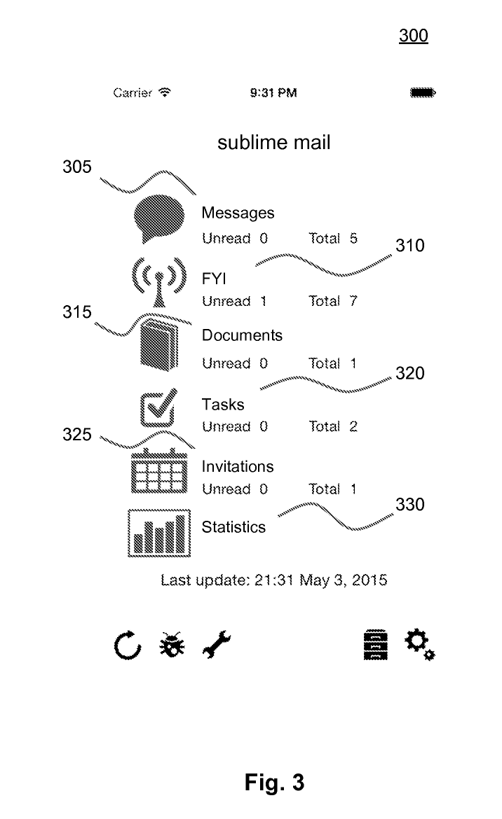

In some embodiments, in place of the current date-ordered list of emails, the system provides a “dashboard” that provides at-a-glance visibility into the ongoing conversations and issues that requires the attention of the user. The dashboard may be constructed on top of the email classifier. FIG. 3 depicts an example dashboard presented on a mobile communications device by the system. Dashboard 300 provides an overview of the distribution of emails across the five classes of messages by displaying the number of email threads that have unread content as well as the total number of email threads in each class.

In this example, the five classes include messages 305, FYI 310, Documents 315, Tasks (or Task Requests) 320, and Invitations 325. Each of the five classes occupy an area on the display (e.g., a touchscreen display) that, when activated, will allow the user to view the details of the class. Rounding out dashboard 300 is an area for the Statistics 330. When Statistics 330 is activated, a screen with various usage statistics associated with the user's account may be provided. This section aims to provide the user with self-awareness about his email habits, enabling him to effect conscious change.

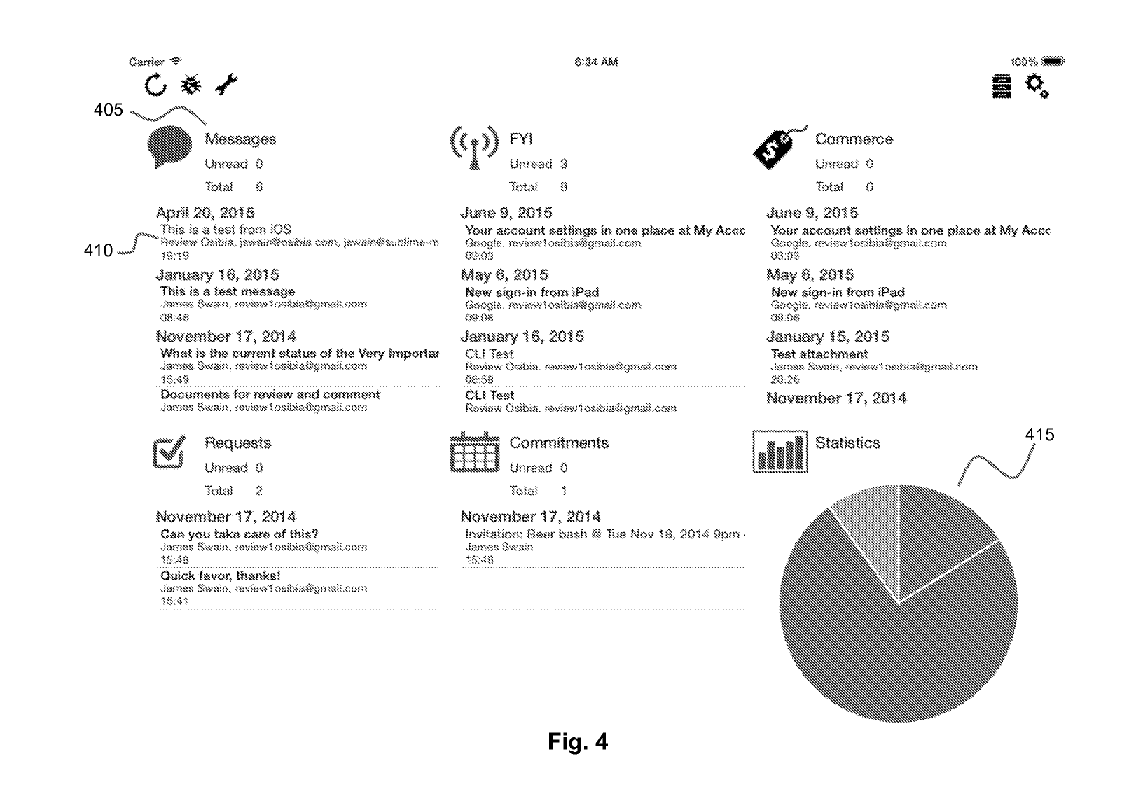

In some embodiments, the system may be adapted to display dashboard 300 on a tablet device. FIG. 4 depicts an example dashboard presented on a tablet. When presented on a tablet, the dashboard 300 is expanded to show the first few threads in each class. For example, threads 405 are provided for the Messages class 410. Dashboard 300 may also provide a representative graph of the statistics 415. Whether dashboard 300 is displayed on a mobile communications device or tablet, the user is able to drill down into each of the classes to view the chronologically ordered list of threads, and then drill down further to view the messages and attachments associated with each thread. The user may also create new threads (compose a new email), update a thread (reply to an email), or invite new participants to join a thread (forward an email).

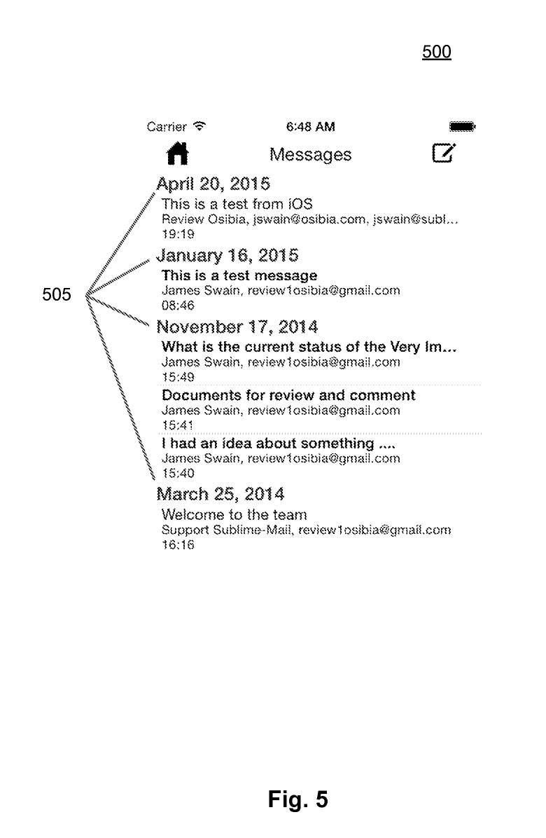

FIG. 5 provides a representative thread view 500 provided by the system when a user drills down into a particular class. In this example, the thread is organized chronologically by calendar days 505. Each calendar day is depicted as a heading, and within each heading is a variety of emails for that day. While this example shows all headings and emails sorted in reverse chronology, the sorting may be performed in a variety of fashions, for example, chronological, alphabetical by sender, chronological with unread emails first, etc.

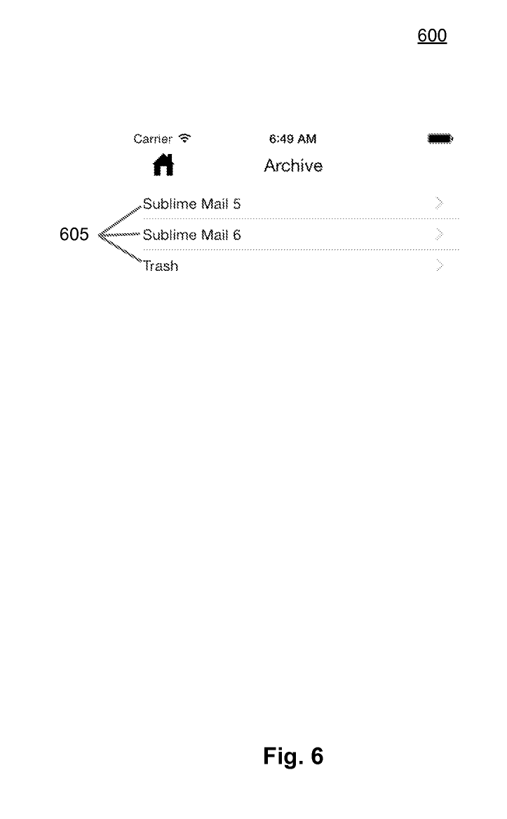

Threads may also be moved to a new class, archived or deleted. The act of moving a thread to a new class not only updates the classification of the thread, but may also provides feedback to the classification system in order to improve future classifications. An archived thread 600, as shown in FIG. 6, can be accessed through the Archive option on the summary screen. The top-level archive view provides for display a set of labels 605 that the user designates for archived messages. From here, the user can drill into any of the archive labels to obtain a thread view as described above for unarchived messages.

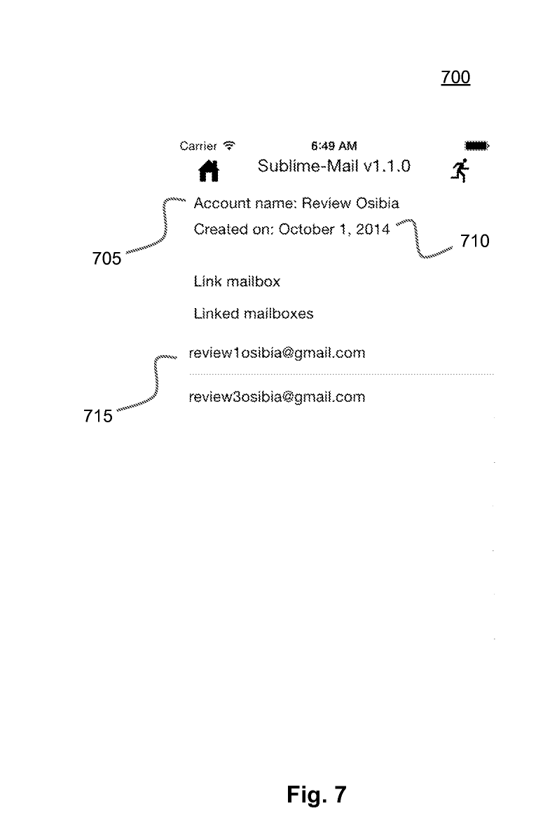

FIG. 7 provides an example profile view of the user. In the profile view section, the dashboard may provide account details such as account name 705 and the date on which the account was created 710. The profile view section may also provide a list of the linked mailboxes 715. While this particular example shows two linked email accounts, any number of email accounts may be linked (e.g., an option to link additional mailboxes may be provided). In some embodiments, the profile view section may also provide options for logging out from the account, reporting a bug, and requesting a feature to be added.

Being able to see how emails are distributed in the inbox on the dashboard, and being able to choose when to devote time to processing them, allows the user to be more productive in processing large number of emails. For example, Task Requests and Messages could be reasonably expected to be time-sensitive. The user might not need to perform the task immediately, but the requestor will often need to find a second user to take on the task if the original user decline. On the other hand, it's very difficult to read and respond intelligently to a new document without first setting aside a block of time to do so. In some aspects of the invention, the system performs the initial, coarse-grain filtering for you that allows you to quickly determine if you need to respond to something immediately or if you have built up a significant reading list that must be addressed. This allows the user to develop a regular and more efficient behavior when approaching emails. For example, with this system, the user might choose to check the Task Request and Message class multiple times per day, the Invitation and FYI classes first thing in the morning and immediately after lunch and the Document class twice a week (during time blocked out for contemplative work).

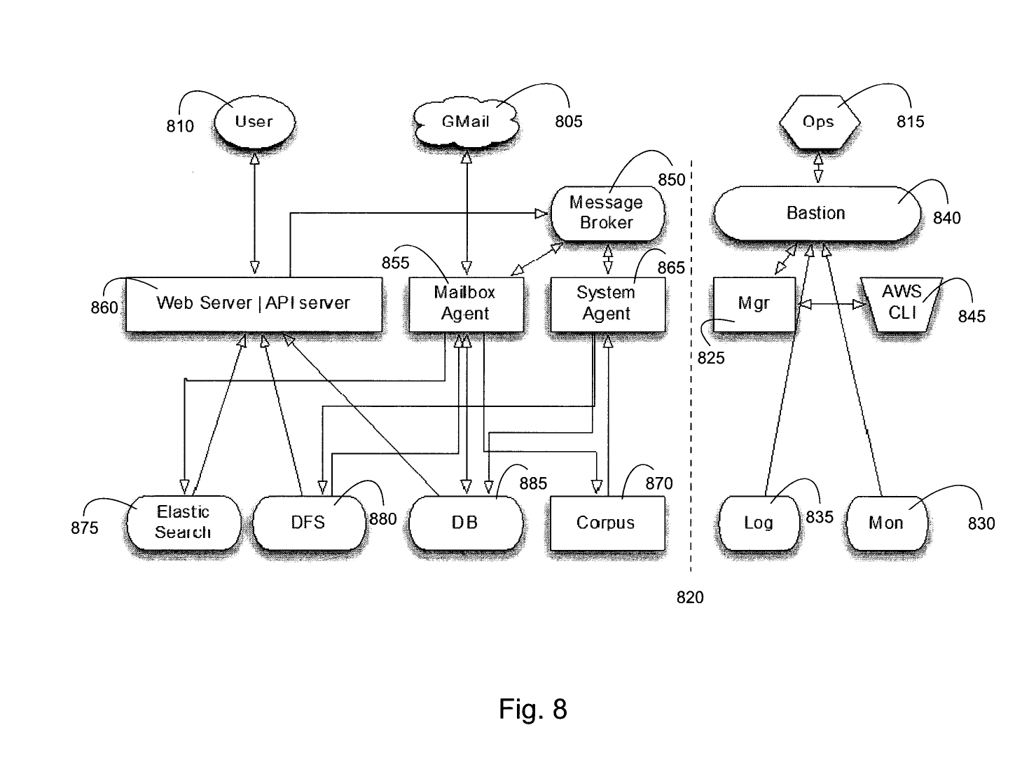

FIG. 8 provides a depiction of a version of the Cloud Services architecture used by the system. The top row shows the external entities that the system interacts with: the mail provider 805, the users 810 and the operations team 815. The internal components are separated into two sections. The right-hand side shows the infrastructure used to manage and monitor the system, and the left-hand side shows the infrastructure that processes customer data. All interactions across the “blood-brain barrier” 820 that separates the two sides must be controlled and tracked. The flow of data through the system is indicated by the various arrows. Not shown in this diagram is the management, monitoring and logging traffic that goes between the Manager 825, Monitoring 830 and Log 835 servers.

A hardened bastion 840 provides access to the management/monitoring portion of the production environment. Each operator has its own account on the bastion server 840. There is no console access to the nodes processing customer data. With access to the bastion 840 the operator will be able to access the web interfaces of the management 825, monitoring 830 and logging 835 servers.

The log server 835 is a standard instance of LogStash (an open source tool for managing events and logs). All the instances of the production cluster forward their logs to the log server. The logs are viewed via a web interface that is tunneled through the bastion host. The monitoring server 830 is a standard instance of the Sensu server (a malleable and scalable monitoring framework). The Sensu client runs on most of the instances of the production cluster and forwards data to the monitoring server 830. The server is responsible for monitoring external interfaces. The current state of the system is viewed via a web interface that is tunneled through the bastion host 840.

Control of Amazon Web Services (AWS) is performed via the programmable AWS command line interface (AWS CLI) 845, in preference to using the console. Access is controlled by an access key that is only accessible to the management server 825. All operations that change the state of the production cluster are performed via the manager RESTful Web API. That Web API is defined by version controlled code that is updated by the system's engineering release process. The manager instance forms a choke point that can be used to control and monitor access to the production system where only well defined operations are permitted.

The synchronous elements of the production cluster (e.g., the apache servers) are decoupled from the external components (e.g., the mail provider) and the asynchronous elements (e.g., the agents) by a massage broker 850. Any user activity that seeks to change the state of the mail server or that will take a long time to accomplish is initiated by queuing a message to the message broker. Sometime later the mailbox agent 855 will dequeue the message and perform the required task.

The Web/API server 860 provides the Web UI and RESTful Web API respectively. Users interact with the system either directly via the Web UI, or via an iOS app that uses the Web API. Furthermore, asynchronous or scheduled tasks that handle raw customer data are performed by workers that run on the mailbox agents 855. Asynchronous or scheduled tasks related to the operation of the cluster, on the other hand, are performed by workers that run on the system agent 865.

In some embodiments, the raw, labeled emails of the corpus 870 are stored in a directory on a same distributed file system 880 (GlusterFS) that is used to hold attachments, graphs, the DB cache and the machine learning rules. In an alternative embodiment, the corpus 870 may be migrated to a dedicated instance. For example, a RESTful Web API may be created to allow the mailbox agent 855 to push raw emails onto the corpus 870 server that will mask the content (removing any personally identifiable information or other sensitive content) before storing the data. The distributed file system 880 may be used to store email attachments and other data, such as machine learning rules, that is not amenable to storage in the database 885.

In some embodiments, raw email data is stored in the database 885 along with all the system data (user account information, classification, etc.). However, this data may be passed into an ElasticSearch cluster 875. The current parsing logic in the Mailbox Agent will be updated to convert raw emails into an appropriate JavaScript Object Notation (JSON) format and submitted to the ElasticSearch cluster 875 via the RESTful Web API. When required, the Web/API server 860 will recover data from the ElasticSearch cluster 875 either by searching for a user-provided string or by selecting a specific message via a unique characteristic (mailbox_id, folder, msg_uid, etc.). Over time, the database 885 should be emptied of everything except system data and system generated metadata.

The mailbox agent 855 may be a stateless instance running several processes (e.g., Celeryd). These processes draw messages from the message broker 850. Each message identifies a task to be performed and provides the data necessary to perform that task. The system runs as many mailbox agents 855 as is necessary to perform all the tasks in a timely manner.

A start_new_mailbox task may be triggered when a user links a new mailbox to an existing account or creates a new account. The task connects to the mail provider's servers to obtain some initial configuration information and performs the initial setup of the mailbox on the system's servers. A continue_new_mailbox task may follow on immediately from start_new_mailbox. It may run repeatedly until the user's mailbox has been completely processed once. The processing captures the current state of all emails in the user's inbox, trash and spam folders. After the user's mailbox has been completely processed once, the check_mailboxes task runs periodically to capture any changes to the mailbox. The task typically runs in a few seconds and is scheduled to run one minute later. Occasionally the task takes longer than one minute to run. In such instances, the check_mailboxes task may re-run immediately.

Both the check_mailboxes and continue_new_mailbox tasks follow similar code paths to pull mail from the IMAP server. The system maintains the identification of the last email retrieved from every email inbox. Each time one of these tasks is run, the list of emails currently available is acquired from the email provider's server. New emails are downloaded from the email provider server in batches to avoid a very large download or a large number of very small downloads, both of which can be problematic. Each new email may be decoded, if necessary, and attachments are separated off and written to the file store. The message is then assigned to a thread and classified. In some embodiments, the data extracted from the email and stored in the database may be used to assign a message to a thread and or class. A subset of raw messages from each inbox is anonymized and appended to the email corpus such that a pool of messages that are representative of the email received by user is created, with a bias towards messages that lie on the classification boundaries.

Statistical sampling is often concerned with avoiding bias. For example, with Presidential election opinion polls, the goal is to get as representative sample of the likely voters as possible to ensure the poll is accurate. However, sometimes it is beneficial to bias the sample in one direction or another. In the case of the system provided, the email classification is performed by a combination of three independent linear classifiers. The linear classifiers operate on vectorized email content and are trained on the labeled corpus. The emails of the labeled corpus form clusters in n-dimensional space. Since the classifiers are concerned with identifying surfaces that separate these clusters, we are less interested in emails that are firmly in one cluster or another, and are more interested in ones that are on the edge of a cluster, particularly if two clusters are close together or overlap. Having more training data on the classification boundaries should lead to more accurate classifiers.

### Web Server

The web server is a functional unit made up of multiple processes running on multiple servers and provides all accessible content. While some of the pages on the web server may provide company and product information, the majority of the pages provide access to user data.

User ID and authorization is generally delegated to a web client, such as Google Single Sign On (Google SSO). When a previously unknown user signs in to the system, a new user account record may be created in the database. This record includes an authorization token that can be used to access the application server. The user can subsequently authorize additional email accounts to be associated with a single account on the system.

When a user returns to view or send email, the user must be authorized again, for example via Google SSO. Most users keep their browser signed into their web client all the time, so the browser and server can silently exchange credentials to authorize the user. From time to time a user will sign out of their account and when they attempt to access the system, they will be redirected to the sign on page to login again. Once a user has been authorized they can view user-specific content that is dynamically created on the web server. The web server filters all database tables by the identification of the authenticated user to ensure that users cannot access any data other than their own.

### Application Server

The application server is functional unit made up of multiple processes running on multiple servers responsible for providing all the data required by a mobile app. Communication with the application server takes place over Secure Sockets Layer (SSL). The application server provides a valid SSL certificate that should be checked by the client.

Users are authenticated to the Application Server via an authorization key that is generated by the system when the user account is created. The authorization key may be embedded in the Hypertext Markup Language (HTML) of the user's profile page inside an <auth_token> tag. In order to access that page the user is authenticated via a web client, such as Google SSO. A mobile client will typically need to use an embedded web browser to perform the steps required by the Google SSO protocol and then parse the HTML for the profile page to extract the authorization key.

Every Hypertext Transfer Protocol (HTTP) request that is generated by the client must include the “Authorization” header with the value “Token <auth_token>” where <auth_token> is the authorization key. Since every Web API operation is authenticated the server can filter all database tables by the corresponding user ID ensuring that each user only has access to their own data.

### Mobile App

The system described herein is designed to not only provide a web client, but also to provide for interactions via a mobile app that run on mobile operating systems like iOS, Android and Windows Mobile.

The design of the mobile app shapes the user's experience and their perception of the email inbox. The system does not present a conventional inbox view, with all the classes of email mixed together. The system only provides a top-level view of the inbox as an executive summary. The mobile app may also provide a mechanism for the user to report bugs and request new features from within the app itself, as discussed above. Decreasing the barrier for users to provide feedback maximizes the likelihood that action will be taken in response to the feedback in a timely manner. In turn, the added responsiveness to customer feedback increases customer engagement and improving customer retention.

The mobile app may communicate with an instance of the application server running in the cloud. A specific hostname may be compiled into the app in order for the app to make first contact with the server. However, every time the app retrieves data required to assemble the executive summary, the app also checks to see an alternative server should be used. The system's server can be configured to direct each user to a different host based on a variety of criteria including location, status or activity. Lastly, the system, whether operating via a web client or a mobile app, may be integrated with a variety of cloud storage providers so that email attachments can be automatically stored on the user's cloud storage account.

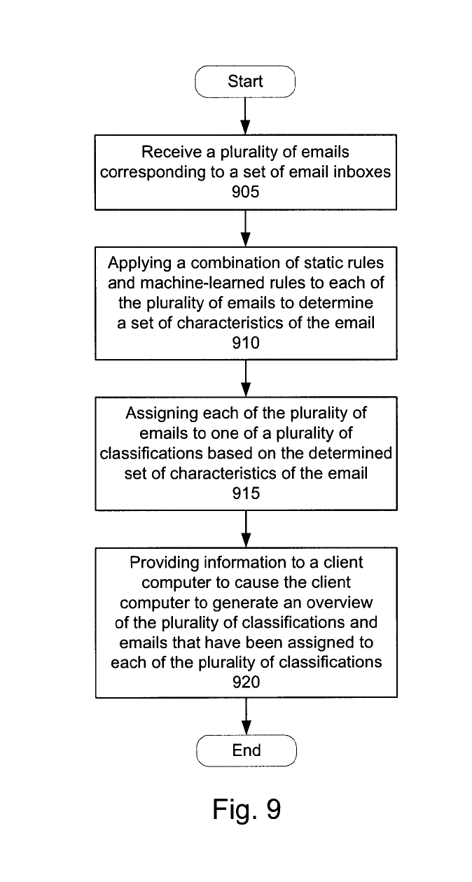

FIG. 9 illustrates an example method for presenting a summarized view relating to a user's emails. In 905, the plurality of emails corresponding to a set of email inboxes is received. Once received, a combination of static rules and machine-learned rules may be applied to each of the plurality of emails in 910. The combinations of rules are applied in order to determine a set of characteristics of the email. Each of the plurality of emails may also be assigned to one of a plurality of classifications based on the determined set of characteristics of the email in 915. Information is then provided to a client computer in 920. The provided information causes the client computer to generate a display of an overview of the plurality of classifications and emails that have been assigned to each of the plurality of classifications.

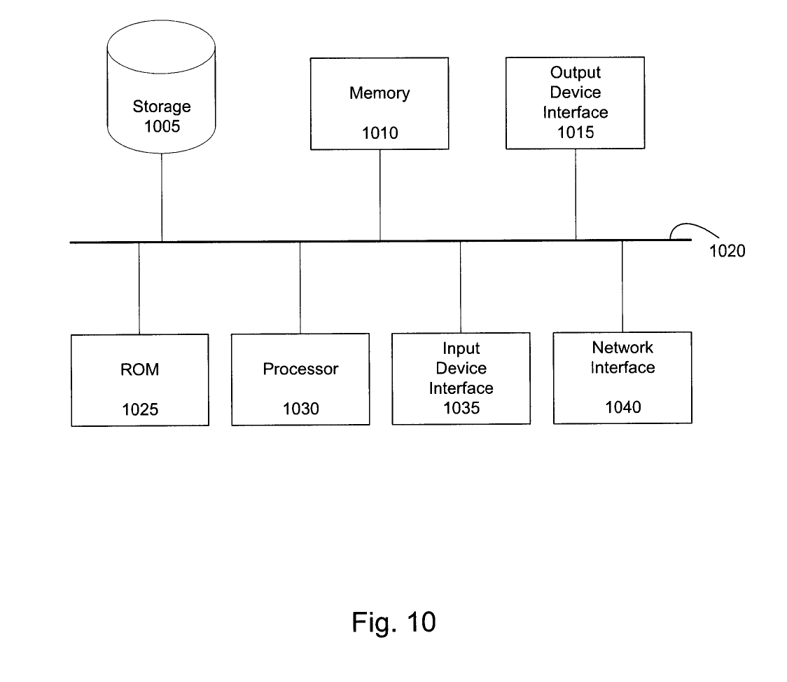

FIG. 10 conceptually illustrates an example electronic system 1000 with which some implementations of the subject technology are implemented. Electronic system 1000 can be a computer, phone, PDA, a tablet or any other sort of electronic device. Such an electronic system includes various types of computer readable media and interfaces for various other types of computer readable media. Electronic system 1000 includes a bus 1020, processing unit(s) 1030, a system memory 1010, a read-only memory (ROM) 1025, a permanent storage device 1005, an input device interface 1035, an output device interface 1015, and a network interface 1040.

Bus 1020 collectively represents all system, peripheral, and chipset buses that communicatively connect the numerous internal devices of electronic system 1000. For instance, bus 1020 communicatively connects processing unit(s) 1030 with ROM 1025, system memory 1010, and permanent storage device 1005.

From these various memory units, processing unit(s) 1030 retrieves instructions to execute and data to process in order to execute the processes of the subject disclosure. The processing unit(s) can be a single processor or a multi-core processor in different implementations.

ROM 1025 stores static data and instructions that are needed by processing unit(s) 1030 and other modules of the electronic system. Permanent storage device 1005, on the other hand, is a read-and-write memory device. This device is a non-volatile memory unit that stores instructions and data even when electronic system 1000 is off. Some implementations of the subject disclosure use a mass-storage device (such as a magnetic or optical disk and its corresponding disk drive) as permanent storage device 1005.

Other implementations use a removable storage device (such as a floppy disk, flash drive, and its corresponding disk drive) as permanent storage device 1005. Like permanent storage device 1005, system memory 1010 is a read-and-write memory device. However, unlike storage device 1005, system memory 1010 is a volatile read-and-write memory, such as random access memory. System memory 1010 stores some of the instructions and data that the processor needs at runtime. In some implementations, the processes of the subject disclosure are stored in system memory 1010, permanent storage device 1005, and/or ROM 1025. For example, the various memory units include instructions for presenting a summarized view of emails in accordance with some implementations. From these various memory units, processing unit(s) 1030 retrieves instructions to execute and data to process in order to execute the processes of some implementations.

Bus 1020 also connects to input and output device interfaces 1035 and 1015. Input device interface 1035 enables the user to communicate information and select commands to the electronic system. Input devices used with input device interface 1035 include, for example, alphanumeric keyboards and pointing devices (also called “cursor control devices”). Output device interface 1015 enables, for example, the display of images generated by the electronic system 1000. Output devices used with output device interface 1015 include, for example, printers and display devices, such as cathode ray tubes (CRT), liquid crystal displays (LCD). Some implementations include devices such as a touchscreen that functions as both input and output devices.

Finally, as shown in FIG. 10, bus 1020 also couples electronic system 1000 to a network (not shown) through a network interface 1040. In this manner, the computer can be a part of a network of computers, such as a local area network, a wide area network, or an Intranet, or a network of networks, such as the Internet. Any or all components of electronic system 1000 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network and a wide area network, an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

We claim:

1. A method comprising:
receiving, at a server, a plurality of emails corresponding to a set of email inboxes;
applying, at the server, a combination of static rules and machine-learned rules to each of the plurality of emails to determine a set of characteristics of the email;
assigning, at the server, each of the plurality of emails to one of a plurality of classifications based on the determined set of characteristics of the email; and
providing, by the server, information to a client computer to cause the client computer to generate a display of an overview of the plurality of classifications and emails that have been assigned to each of the plurality of classifications.

2. The method of claim 1, wherein each of the set of email inboxes corresponds to a unique web client providing email services.

3. The method of claim 1, wherein the plurality of classifications includes at least two classifications selected from a group consisting of personal emails, informational emails, documents, requests, and invitations.

4. The method of claim 1, wherein the combination of static rules and machine-learned rules are applied to at least one of a subject line of the email, a body of the email, and metadata of the email.

5. The method of claim 1, wherein applying the combination of the static rules and the machine-learned rules to each of the plurality of emails includes first applying the static rules to determine the classification of the email, and when applying the static rule is inconclusive, then applying the machine-learned rules to determine the classification.

6. The method of claim 1, further comprising:
extracting, by the server, information embedded into text of the plurality of emails,
wherein assigning each of the plurality of emails to one of the plurality of classifications is further based on the extracted information.

7. The method of claim 1, further comprising:
associating, at the server, each of the plurality of emails to one of a set of threads,
wherein the emails that have been assigned to each of the plurality of classifications are generated in the overview as threads to which each of the plurality of emails is associated.

8. A non-transitory computer-readable medium comprising instructions stored therein, the instructions for presenting a summarized view of a plurality of emails, and the instructions which when executed by a system, cause the system to perform operations comprising:
receiving the plurality of emails corresponding to a set of email inboxes;
applying a combination of static rules and machine-learned rules to each of the plurality of emails to determine a set of characteristics of the email;
assigning each of the plurality of emails to one of a plurality of classifications based on the determined set of characteristics of the email; and
providing information to a client computer to cause the client computer to generate a display of an overview of the plurality of classifications and emails that have been assigned to each of the plurality of classifications.

9. The non-transitory computer-readable medium of claim 8, wherein each of the set of email inboxes corresponds to a unique web client providing email services.

10. The non-transitory computer-readable medium of claim 8, wherein the plurality of classifications includes at least two classifications selected from a group consisting of personal emails, informational emails, documents, requests, and invitations.

11. The non-transitory computer-readable medium of claim 8, wherein the combination of the static rules and the machine-learned rules are applied to at least one of a subject line of the email, a body of the email, and metadata of the email.

12. The non-transitory computer-readable medium of claim 8, wherein the instructions for causing the system to perform the operation of applying the combination of the static rules and the machine-learned rules to each of the plurality of emails includes instructions for causing the system to perform the operation of first applying the static rules to determine the classification of the email, and when applying the static rule is inconclusive, then applying the machine-learned rules to determine the classification.

13. The non-transitory computer-readable medium of claim 8, further comprising instructions for causing the system to perform the operation of:
extracting information embedded into text of the plurality of emails,
wherein the instructions for causing the system to perform the operation of assigning each of the plurality of emails to one of the plurality of classifications is further based on the extracted information.

14. The non-transitory computer-readable medium of claim 8, further comprising instructions for causing the system to perform the operation of:
associating each of the plurality of emails to one of a set of threads,
wherein the emails that have been assigned to each of the plurality of classifications are generated in the overview as threads to which each of the plurality of emails is associated.

15. A system for presenting a summarized view of a plurality of emails, the system comprising:
one or more processors; and
a machine-readable medium including instructions stored therein, which when executed by the processors, cause the processors to perform operations comprising:
receiving the plurality of emails corresponding to a set of email inboxes;
applying a combination of static rules and machine-learned rules to each of the plurality of emails to determine a set of characteristics of the email;
assigning each of the plurality of emails to one of a plurality of classifications based on the determined set of characteristics of the email; and
providing information to a client computer to cause the client computer to generate a display of an overview of the plurality of classifications and emails that have been assigned to each of the plurality of classifications.

16. The system of claim 15, wherein each of the set of email inboxes corresponds to a unique web client providing email services.

17. The system of claim 15, wherein the plurality of classifications includes at least two classifications selected from a group consisting of personal emails, informational emails, documents, requests, and invitations.

18. The system of claim 15, wherein the combination of the static rules and the machine-learned rules are applied to at least one of a subject line of the email, a body of the email, and metadata of the email.

19. The system of claim 15, wherein the instructions for causing the processor to perform the operation of applying the combination of the static rules and the machine-learned rules to each of the plurality of emails includes instructions for causing the system to perform the operation of first applying the static rules to determine the classification of the email, and when applying the static rule is inconclusive, then applying the machine-learned rules to determine the classification.

20. The system of claim 15, further comprising instructions for causing the processor to perform the operation of:
extracting information embedded into text of the plurality of emails,
wherein the instructions for causing the processor to perform the operation of assigning each of the plurality of emails to one of the plurality of classifications is further based on the extracted information.
